(19) United States
(12) Patent Application Publication
(10) Pub. No.: US 2007/0016952 A1
(43) Pub. Date: Jan. 18, 2007

(54) MEANS FOR PROTECTING COMPUTERS FROM MALICIOUS SOFTWARE

(76) Inventor: Gary STEVENS, Jordan, MN (US)

Correspondence Address: GODFREY & KAHN S.C., 780 NORTH WATER STREET, MILWAUKEE, WI, 53202, US

(21) Appl. No.: 11/457,619

(22) Filed: Jul. 14, 2006

Related U.S. Application Data
(60) Provisional application No. 60/699,900, filed on Jul. 15, 2005.

(51) Int. Cl. G06F 12/14

(52) U.S. Cl. 726/24

(57) ABSTRACT

A computer security system and method using selective permission or denial of requests to create or modify program file to prevent introduction of malware onto a protected computer system. The selective permission or denial of requests is based on comparison of information regarding the requested action and a list of rules.

### CROSS REFERENCE TO RELATED APPLICATION

The present application claims priority to an earlier filed U.S. provisional patent application Ser. No. 60/699,900, filed on Jul. 15, 2005, and entitled Means For Protecting Computers From Malicious Software, the disclosure of which is incorporated herein by reference.

### BACKGROUND

There is quite an interesting drama occurring on the Internet today. Email, the World Wide Web, Instant Messaging, E-commerce, and other online functionality are generally available to more people than ever before. There is presently a significant impediment to such use, however. Unfortunately, the trustworthiness of the Internet itself may be presently compromised by malicious software activity, including computer virus, spyware, adware, trojans, worms, browser hijackers, etc. (collectively “malware”). People are having their identities and private information compromised, computers are being slowed or rendered inoperable, and the usage of online services is being denied by malware which is typically covertly installed on machines of unsuspecting computer users. Many published statistics suggest that this trend is becoming worse, with no true relief in sight.

A conventional approach to mitigating risks posed by malware is by using one or more commercially available software products generally known as anti-virus, anti-spyware, and other similar software applications or suites of applications (collectively security software or “anti-malware”). These popular anti-malware products are conventionally considered essential to compute safely while attached to the Internet. These anti-malware products differentiate between beneficial software and malware by virtue of binary patterns, or “signatures” which the anti-malware vendor engineers use to uniquely identify known malicious software threats. A potential scenario of a malware assault and a conventional approach to addressing the assault may unfold as follows:

A malicious program (malware) is written and released onto the Internet. If the malware is “successful”, it propagates and infects some population of computers. Methods of release and propagation vary, but typical routes of infection include email systems, malicious web sites targeting unsecure web browser functions, and other avenues exposed by the computer's Internet-facing software.

Eventually, the malware will become noticed by one of the anti-malware vendors, who will then endeavor to secure a copy of the malware, reverse engineer the malware, and decide upon a pattern within the malware's binary code (a “signature”) to uniquely identify it. The anti-malware vendor will then distribute this new signature to their subscribers, and these subscribers then become able to detect this particular threat (and potentially remove it if infection has already occurred).

In general terms, this conventional approach is referred to as a “signature based” and “reactive” attempt to address the threat of malware.

Unfortunately, in this conventional model, the time interval between the release of malware and the distribution of a “remedy” is such that the malware producers can enjoy considerable distribution and attendant damage with their malware in the interim. Malware may successfully achieve its nefarious goals within this conventional framework. Furthermore, malware authors are capable of mutating their binary code so as to avoid recognition using existing signatures, and re-releasing these mutated versions, causing the above cycle to repeat.

Thus, the problem of malware will never be “cured” by this conventional reactionary, signature-based solution; the malware lifecycle is merely shortened, and shortened to a timeframe that is not a truly significant deterrent to the creators of malware.

A further conventional approach used today intending to bring safety and security to the Internet is to use network traffic filtering mechanisms known as “firewalls”, which can be implemented typically as either dedicated computing systems or as software integrated into individual computers. The fundamental mechanism of the firewall is to selectively restrict network traffic based on a potentially complex set of rules.

Such firewalls can be configured to block traffic to arbitrary domains, for example disallowing all network traffic to specific web sites that are known to host malicious content. Unfortunately, this “black list” approach requires a list of known malicious domains, which is extremely unwieldy because such domains tend to be numerous and volatile. Alternatively a firewall might be configured to only allow traffic to known good domains, for example only allow traffic that appears to come from the United States, or from with the domain of the enterprise to which the computer is connected. This “white list” approach tends to severely restrict the computing experience.

A general purpose firewall could potentially also be configured to block network traffic based on the type of said traffic, such as to allow email protocols but block chat protocols, etc. Again, this technique can be valuable in disallowing activities on the Internet that could potentially lead to the introduction of malware, it does so at the cost of severely restricting the computing experience.

Improvements to systems and methods of security available for personal and business computers to address the growing malware concerns are desirable.

### SUMMARY

The present invention relates generally to providing security against the installation and operation of malware on computers. More specifically, the present invention relates to a system and method for the prevention of the installation of unwanted or malicious software onto a computer system. One embodiment of the method may intercept requests from applications installed on a computer system to perform file system operations, and if the request is an attempt to create or modify a program file, the request may be denied. Other file system requests in this embodiment may be processed normally. In another embodiment, different applications installed on a computer system may be selectively extended or denied the privilege of modifying and/or creating program files. Such an approach to selectively extending or denying privileges to different applications may be based on a relative level of risk associated with or assigned to the applications.

### BRIEF DESCRIPTION OF THE DRAWINGS

The accompanying drawing figures, which are incorporated in and constitute a part of the description, illustrate several aspects of the invention and together with the description, serve to explain the principles of the invention. A brief description of the figures is as follows:

FIG. 1 is a flowchart illustrating a file system file blocking mechanism according to the present invention that may be integrated into a file system driver of a computer system.

FIG. 2 is an example set of rules according to the present invention, including rules that preclude any of several typical types of executable files from being created or modified by any process or application operating on the computer system, and allowing all other file types to be created or modified by any other process or application operating on the computer system.

FIG. 3 is an example set of rules according to the present invention, including rules that allow an application named SafeApp1 access to EXE files, allows example application SafeApp2 access to a specific file named “AspecificFile” in a specific folder named “AspecificFolder”, prevents all other applications from accessing program files, and allows unrestricted access to all other files by all other applications.

FIG. 4 is a flowchart illustrating a routine according to the present invention, allowing suspension of file blocking implemented within the controlling user application.

### DETAILED DESCRIPTION

Reference will now be made in detail to exemplary aspects of the present invention which are illustrated in the accompanying drawings. Wherever possible, the same reference numbers will be used throughout the drawings to refer to the same or like parts.

The present disclosure presents an improved approach to the challenge of protecting the vast Internet computing environment from the “contamination” of computers with malicious software without the computer operator/user having consented or even being aware that such programs have been installed.

Generally speaking, the malware may embed itself into an executable file, also known as a program file, on a non-volatile storage device (typically a disk drive) on the afflicted computer system. An approach is described herein which blocks the admittance of files which may seek to introduce malware into a computer and thus prevent such files from being written to the storage device.

The introduction of potentially malicious or undesirable program files to the system may be carried out by intercepting attempts by various applications to create or modify program files and causing these attempts to fail unless the application requesting access is granted the privilege of touching program files. This is a non-reactive, non-signature-dependent approach.

Additionally, it is common for different forms of malware to adjust certain system configuration parameters (in Microsoft™ Windows™, for example, the system “registry” is one such affected area) in order to cause the malicious code to automatically load into memory without any action (or knowledge) from the computer user. It is anticipated that the methods and systems described herein can be used to block registry manipulation on a per-process, per-registry subkey, and a per-registry key manner.

The potential file creation/modification blocking and “rule interpretation algorithms” of the present disclosure can be implemented as a file system driver, a file system filter driver, or other technology as appropriate for the given operating system. Obviously, a desirable attribute of the selected technology may include operation at a securely protected processing level, such that a malicious program could not easily defeat the protective functionality, even with a specifically directed attack against such a mechanism. A desirable implementation may incorporate per-process name, per-folder name, per-file name, and per-file type access control into the operating system itself.

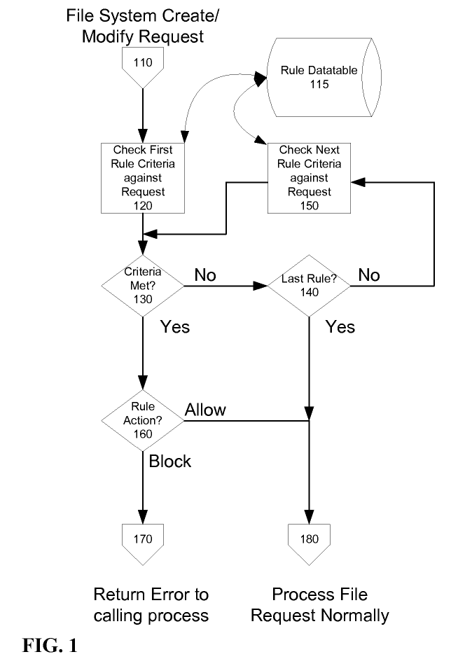

As the flowchart of FIG. 1 illustrates, an algorithm within a file system, such as might be found on virtually every computer, can be used to control access to program files within the computing system. A file system filter driver 110, chosen as appropriate for the given operating environment, may intercept all application attempts within the file system to create files or to open files with write privileges. This process may collect or sense up to four or more pieces of information about the request: the name of the requesting process, the name of the file requested, the type (extension) of the file requested, and the folder of the requested file. These pieces of information sensed or collected may then be used to access a collection of rules in a rule datatable 115 to determine the disposition of the file request. A first rule of the collection of rules in rule datatable 115 may be inspected by a comparator beginning with box 120 and compared to the up to four pieces of information collected or sensed.

If the four pieces of information from the request do not match the criteria specified in the rule in a decision box 130, then rule datatable 115 may be checked to see if there are more rules in rule datatable 115 that have not been inspected with regard to the present file create/modify request. If rule datatable 115 is exhausted, in decision box 140 the file request operation is allowed to proceed without disruption in box 180. If rule datatable 115 is not exhausted, as determined at decision box 140, meaning there are additional rules in the datatable to inspect, the next rule in rule datatable 115 may now be inspected in box 150 to see if the four pieces of information from the request match the criteria specified in the present rule.

This process may proceed sequentially through rule datatable 115 until a rule within the datatable is found with criteria matching all of the up to four pieces of information from the original request, satisfying one possible exit to decision box 130. Alternatively, the process may proceed until no criteria of rules within rule datatable 115 are met and the list of rules is exhausted, as determined in decision box 140. If a matching rule is discovered during this process, the behavior specified by the matching rule will be used in box 160 and may include causing the original file system request to proceed normally in box 180 or returning an error to the requesting process in box 170.

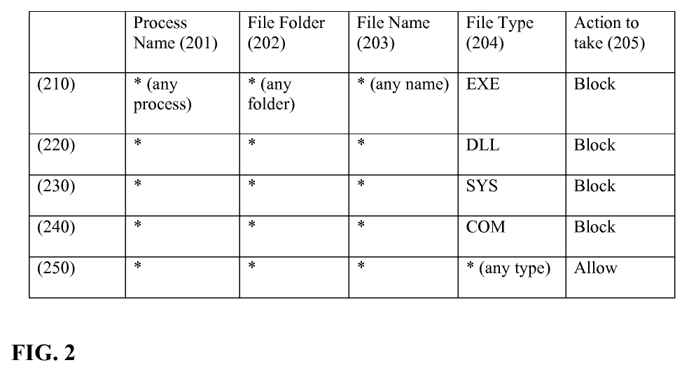

The approach described above with reference to FIG. 1 may be appreciated further by examining the format of rule datatable 115, which is illustrated in example form in FIG. 2. Datatable 115 may contain a series of rows, each of which is illustrated as containing five elements: a process name text string 201, a file folder name text string 202, a file name text string 203, a file type 204, and an action 205, allow or deny, to take if the preceding four elements match the respective pieces of information sensed or collected of the original file request as made by any arbitrary application. The different rules 210, 220, 230, 240 and 250 are illustrated within datatable 115 as horizontal rows which may include the above-described strings 201, 202, 203 and 204.

One preferred approach which may be included in the system described herein to providing both of the above actions (blocking or enabling the creation/modification of executable files on a per-process basis) may be carried out based on a field-modifiable control language. This language may be utilized within datatable 115, and may include the following attributes:
1. Specific fields may be provided in each line of a control language so as to define a “rule” that contains criteria to determine whether to apply said rule to any given system file create/open request, and, if applied, to govern whether said request is to be Blocked or Allowed.
2. A rule may be applicable to a given request if the criteria field(s) (for example but not limited to, process, folder, filename, filetype) are consistent with the specific file open/create request being attempted.
3. Wildcards may be permitted for any of the criteria fields such that special characters such as “*” or “?” may be used to indicate matching of entire text strings or of individual characters.
4. If a particular rule does not apply based on the criteria fields, subsequent rules may be inspected sequentially for applicability.
5. If a particular rule does apply based on the criteria fields, the “Action” field governs behavior of the file blocking mechanism.
6. All rules may be tested in sequence against the request to determine if any rule may govern action based on the request. If any rule applies, the specified action associated with a matching request may be carried out. If no rules apply, i.e., the specifications of none of the rules match the request, the request is allowed to proceed (it is not blocked) by default. Alternatively, the default can be that the rules must be set up to default to deny any request if no rule is matched.

Note that FIG. 2 describes an example set of rules that simply precludes the creation/modification of several typical types of executable files from being created by any process on the computer, while allowing all other file types to be freely created or modified by any other process on the computer.

The interpretation of the rules in datatable 115 in FIG. 2 may be as follows:

Rule 210: If a request to modify or create a file is made by an application with the name of (any application), and the name of the file is (any name), and the location of the file is (any folder) and the type of the file is (EXE), then deny access. If any of these criteria do not match the attempted file operation, examine the next rule.

Rule 220: If a request to modify or create a file is made by an application with the name of (any application), and the name of the file is (any name), and the location of the file is (any folder) and the type of the file is (DLL), then deny access. If any of these criteria do not match the attempted file operation, examine the next rule.

Rule 230: If a request to modify or create a file is made by an application with the name of (any application), and the name of the file is (any name), and the location of the file is (any folder) and the type of the file is (SYS), then deny access. If any of these criteria do not match the attempted file operation, examine the next rule.

Rule 240: If a request to modify or create a file is made by an application with the name of (any application), and the name of the file is (any name), and the location of the file is (any folder) and the type of the file is (COM), then deny access. If any of these criteria do not match the attempted file operation, examine the next rule.

Rule 250: If a request to modify or create a file is made by an application with the name of (any application), and the name of the file is (any name), and the location of the file is (any folder) and the type of the file is (any type), then allow access.

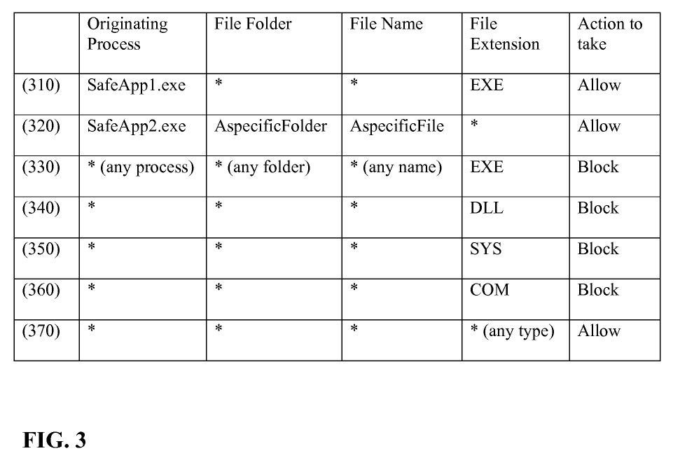

Since it may be desirable in some situations to extend the privilege to modify or amend program files to some specific application(s), for the purposes of allowing automatic program updates/fixes, for example, a rule table according to the present disclosure may have sufficient flexibility to provide this capability. The example set of rules of FIG. 3 demonstrates how one might extend certain privileges to specific application programs. The example allows an example application named SafeApp1 access to all EXE files by the rule (310), then allows example application SafeApp2 access to a specific file named “AspecificFile” in a specific folder named “AspecificFolder” by rule (320), prevents all other applications from accessing program files, and allows unrestricted access to all other files by all other applications by rules 330 thru 370, which correspond identically to rules 210-250 in the previous example.

It may also be noted that an alternative embodiment of a datatable according to the present disclosure may provide for collections of strings in any of the criteria elements, as opposed to singular individual strings, and may have significant advantages of convenience in specifying rules.

A further alternative embodiment of a datatable according to the present disclosure may provide for negative logic in the criteria fields. As an example, a useful rule might be interpreted as: if the requesting application name does NOT match any of the application name(s) specified by this rule, consider the application name criteria met.

In any of the above-described embodiments, a user application such as an editor may also be provided so as to allow manipulation or editing of the rules within the ruletable.

A feature may also be included in the various embodiments of the process described above to provide some sort of user feedback, such as an audible alert or a balloon tip, when file requests are blocked. While the process described herein may operate to protect a computer system without requiring user intervention, it may be desirable to indicate in some fashion to a user of the computer system that the computer system is being threatened. Such as warning may prompt the user to take additional or different measures in enhance protection of the computer system against unwanted intrusion of malware.

Since the addition of new and desirable software programs, for example, is a deliberate act, a means may be provided for the user to “suspend” the file-blocking mechanism when the user wishes to perform such a deliberate act.

For convenience and robustness of protection, the system and method of the present disclosure may contain a feature to automatically resume protection, once suspended, after a user-specified time interval. Since the suspension of the file-blocking mechanism is a necessary act to install software, the user may be advised to refrain from activities that might increase the vulnerability of the computer (web browsing, opening email attachments, use of instant messenger type programs, etc.) while the file-blocking mechanism is suspended.

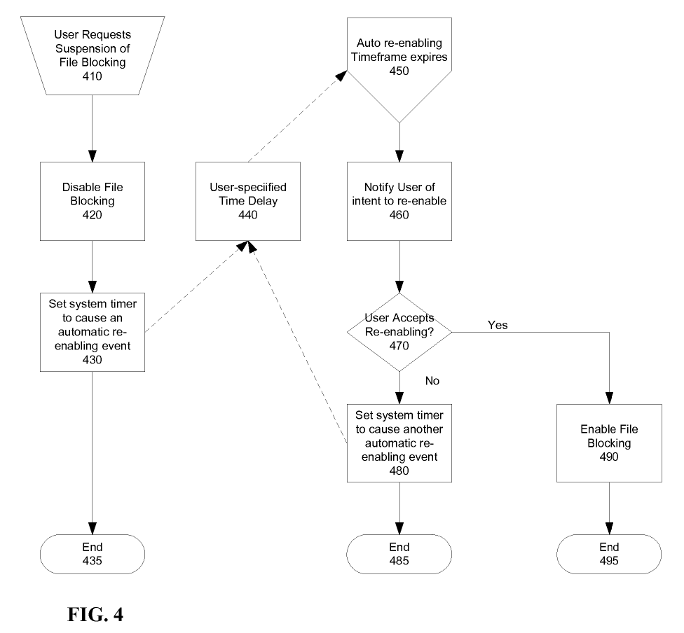

The flowchart of FIG. 4 illustrates one possible implementation of this suspension of protection mechanism in the form of a disabler 400. When a user makes the request to suspend file blocking in box 410, in addition to performing the actions necessary to disable the file blocking mechanism in box 420, a system timer 430 may be activated.

When the system timer 430 event occurs upon the expiration of a user-specified time delay 440, a code thread of box 450 executes. This code may remind the user that file blocking is still suspended in box 460, and may query if the user would like to re-enable the file blocking mechanism in decision box 470. If the user chooses in box 470 not to re-enable file blocking at this time, the system timer may be restarted in box 480. This action may then reinitiate the delay and query cycle of 440, 450, 460 and 470, such that the user may be reminded again of the suspension and whether to re-enable file blocking. If the user chooses in box 470 to re-enable file blocking, the actions necessary to enable the file blocking mechanism (for example but not limited to the file blocking approach of FIG. 1) may be taken in box 490.

It can be appreciated that the user may wish to specify an arbitrary time delay interval for the re-enabling reminder in boxes 430 or 480. It can also be appreciated that the user may wish to specify that no automatic re-enabling reminder will occur, to effectively cause indefinite suspension of file blocking, presumably to be manually re-enabled by the user when the user wishes to do so.

A file blocking approach to computer security as disclosed herein describes an approach to controlling the admittance, without the awareness of the user, of malicious or unwanted program software components onto a computer system. The invention is not dependent on advanced knowledge of signatures of the malicious software, and may therefore provide an active, rather than a reactive, solution to the problem of malware propagation. Mechanisms such as described herein may thwart malicious or undesirable software installation by controlling a computer system's ability to create or modify executable files on a per-process, per-folder, per-filename, and/or per-file type basis. A rule-based mechanism according to the present disclosure may provide significant flexibility to the file blocking mechanism so as to permit balancing between total system lockdown and locking only those applications that present the most significant risk of admitting malicious software while allowing other, more trusted, applications the ability to touch program software components.

What is claimed is:

1. A method of protecting a computer system from malware, the method comprising:
providing a file blocking system within the computer system, the computer system including memory into which may be written one or more program files;
intercepting any requests for the creation of program files and the modification of program files within the memory of the computer system;
determining information regarding the program requesting the creation or modification of the program files and information regarding the requested program file to be created or modified;
comparing information regarding the requesting program and the requested program file with a datatable including at least one rule;
selectively permitting the requested program file to be created or modified within the memory of the computer based on the comparison of the at least one rule in the datatable with the determined information.

2. The method of claim 1, wherein the determined information includes one or more of: the name of the program file to be created or modified, file type of the program file to be created or modified, the file location of the program file to be created or modified, and requesting program name.

3. The method of claim 1, wherein each rule of the datatable includes specification for program file name, file type, file location and requesting program name, and each rule indicates whether the requesting program should be allowed to create or modify the program file based on a comparison of the determined information and the specification of the rule.

4. The method of claim 3, wherein the specification of each rule of the datatable is editable.

5. The method of claim 4, wherein a user of the computer system may edit the specification of any of the rules of the datatable.

6. The method of claim 4, wherein a user of the computer system may create new rules including specification of program file name, file type, file location and requesting program file name, and a user-created rule may indicate selectively whether creation or modification of program files may be allowed based on a comparison of the specification with the determined information.

7. The method of claim 1, further comprising selectively suspending use of the datatable to selectively control creation or modification of program files at the request of a user of the computer system.

8. The method of claim 7, wherein the selective suspension of use of the datatable is temporary and further comprising resuming the use of the datatable after expiration of a predetermined length of time of suspension.

9. The method of claim 7, further comprising querying the user after a predetermined length of time whether to continue the suspension of the datatable to selectively control creation or modification of program files and resuming use the datatable upon request of the user.

10. The method of claim 1, wherein the specification of any rule of the datatable may include negative specifications.

11. The method of claim 1, wherein the memory of the computer includes a non-volatile storage device.

12. The method of claim 1, wherein each rule in the datatable is addressed sequentially until the specification of a rule matches the determined information and the requested program file creation or modification is selectively carried out based on the matched rule.

13. The method of claim 1, wherein the datatable includes more than one rule having predetermined criteria, and further comprising addressing each rule sequentially until the criteria of one of the rules is satisfied by the determined information and the requested program file creation or modification is selectively carried out based on the satisfaction of the criteria of the one rule.

14. A fileblocking system for protecting a computer system, the fileblocking system comprising:
means for intercepting any request by a requesting program to create a new program file on the computer system and any request by a requesting program to modify an existing program file within memory of the computer system;
a datatable containing one or more rules, each rule including specifications and an indicated action specifying whether the requested program file creation or modification should be executed by the computer system;
means for determining information upon intercepting a request, the information determined including a name of the program file requested to be created or modified, a type of program file requested to be created or modified, a location of the program file to be created or modified, and a name of the requesting program;
means for comparing the determined information with the specification of any rules in the datatable;
means for allowing the computer system to selectively carry out the requested program file creation or modification based on the indicated action of any rule in the datatable for which the determined information matches the specification of the rule.

15. The fileblocking system of claim 14, further including a disabler for selectively disabling application of the rules to program file creation and modification requests.

16. The fileblocking system of claim 15, wherein the disabler is capable of re-enabling application of the rules to program file creation and modification requests after a predetermined length of time.

17. The fileblocking system of claim 15, wherein the disabler is capable of querying the user to re-enable application of the rules to program file creation and modification requests after a predetermined length of time.

18. The fileblocking system of claim 14, further comprising an editor for permitting the user to modify rules in the datatable.

19. The fileblocking system of claim 18, wherein the editor permits the user to create new rules in the datatable and delete existing rules from the datatable.

20. The fileblocking system of claim 14, wherein the memory of the computer system includes a non-volatile storage device.

21. The fileblocking system of claim 14, wherein the datatable is capable of including a ruling that includes a negative limitation.

22. A fileblocking system for protecting a computer system, the fileblocking system comprising:
a datatable containing one or more rules, each rule including specifications and an indicated action specifying whether the requested program file creation or modification should be executed by the computer system;
a file system filter driver for intercepting any request by a requesting program to create a new program file on the computer system and any request by a requesting program to modify an existing program file within memory of the computer system, and determining information upon intercepting a request, the information determined including at least two of the following: a name of the program file requested to be created or modified, a type of program file requested to be created or modified, a location of the program file to be created or modified, and a name of the requesting program;
a comparator for comparing the determined information with the specification of any rules in the datatable, and allowing the computer system to selectively carry out the requested program file creation or modification based on the indicated action of any rule in the datatable for which the determined information matches the specification of the rule.
